(19) United States
(12) Patent Application Publication
(10) Pub. No.: US 2015/0331578 A1
(43) Pub. Date: Nov. 19, 2015

(54) ACTIVE SUMMARIES IN USER INTERFACES TO COLLABORATION SERVICES

(71) Applicant: Microsoft Corporation, Redmond, WA (US)

(72) Inventors: Jonathan Fred Keslin, Seattle, WA (US); Dina Ayoub Mahmoud Ayoub, Redmond, WA (US); Lionel A. Robinson, Seattle, WA (US); Krista Bendig, Redmond, WA (US); Philip Eric Kuo, Issaquah, WA (US); Carlos German Perez, Seattle, WA (US)

(73) Assignee: Microsoft Corporation, Redmond, WA (US)

(21) Appl. No.: 14/277,039

(22) Filed: May 13, 2014

(51) Int. Cl. G06F 3/0481; G06F 17/30; G06F 3/0482; G06F 3/0484; H04L 29/08

(52) U.S. Cl. CPC G06F 3/04817; G06F 3/04842; H04L 67/10; G06F 3/0482; G06F 17/30011

(57) ABSTRACT

Disclosed herein are systems, methods, and software to enhance the user experience with collaboration services. In at least one implementation, the presentation of a user interface to a collaboration service is enhanced by identifying collaboration sites associated with a user and identifying events that occurred with respect to the collaboration sites. Active summaries are then surfaced in the user interface that correspond to the collaboration sites associated with the user. In addition, active elements are surfaced in the active summaries that are indicative of at least the events that occurred with respect to the collaboration sites associated with the user.

### TECHNICAL FIELD

Aspects of the disclosure are related to computing hardware and software technology, and in particular, to collaboration services and applications.

### TECHNICAL BACKGROUND

Online collaboration services enable organizations to create and manage focused sites to support collaboration and information dissemination, as well as other features and functions. Some online collaboration services provide document and file management capabilities, social media tools, intranet portals, website hosting, and enterprise search, as well as many other capabilities. SharePoint® Online from Microsoft® is just one example of an online collaboration service.

In a typical experience, a user logs into an online collaboration service over the Internet or some other type of network access. A home page is presented to the user upon logging in that includes links to the various sites or groups to which the user belongs. In some cases the links are thumbnail representations of the sites. The user can navigate to any of the sites by clicking on or otherwise selecting the links.

It is not uncommon for a given user to belong to or otherwise be associated with several collaboration sites. For example, a user in an organization may belong to collaboration sites for multiple teams, departments, and other sub-organizations. This presents a challenge in that the user must navigate to each individual site in order to be up-to-date with respect to the collaboration activity on the site. The problem is only exacerbated as a user becomes associated with more and more sites and may eventually become overwhelming to the point where belonging to multiple collaboration sites is more of a hassle than a productivity-enhancing experience.

Previous solutions to this problem focus on aggregating specific types of information that may be found across collaboration sites to lessen the burden associated with being involved in many collaboration sites. Specific types of information can be aggregated from across multiple sites and then presented in a user's home page. In an example, social news feeds in multiple collaboration sites can be monitored and only relevant or recent posts surfaced in the home page for a user to consume. In another example, task items created across a user's collaboration sites may be aggregated such that a list of tasks can be presented in the home page.

### OVERVIEW

Provided herein are systems, methods, and software to enhance the user experience with collaboration services. In at least one implementation, the presentation of a user interface to a collaboration service is enhanced by identifying collaboration sites associated with a user and identifying events that occurred with respect to the collaboration sites. Active summaries are then surfaced in the user interface that correspond to the collaboration sites associated with the user. In addition, active elements are surfaced in the active summaries that are indicative of at least the events that occurred with respect to the collaboration sites associated with the user.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a collaboration scenario in an implementation in which a collaboration application interacts with a collaboration service.

FIG. 2 illustrates a collaboration process that may be employed by a collaboration service in an implementation.

FIG. 3 illustrates a collaboration process that may be employed by a collaboration application in an implementation.

FIG. 4 illustrates a collaboration scenario in an implementation.

FIG. 5A illustrates a home page in an implementation.

FIG. 5B illustrates a home page in an implementation.

FIG. 6 illustrates a home page in an implementation.

FIG. 7 illustrates a home page in an implementation.

FIG. 8 illustrates a home page in an implementation.

FIG. 9 illustrates a collaboration environment suitable for implementing any of the collaboration applications, services, processes, and operational scenarios disclosed herein with respect to FIGS. 1-8.

### TECHNICAL DISCLOSURE

Implementations disclosed herein enable enhanced user experiences with respect to collaboration services. Active summaries of the various collaboration sites for a user may be presented in a user interface to a collaboration service. Each of the active summaries includes active elements through which information may be surfaced that is indicative of events that occur in association with the collaboration sites. In some implementations the active summaries are presented in a home page such that the user is presented with the information in the active elements upon logging into a service. In this manner, users may be more readily and conveniently updated on collaboration activity that may be occurring across their various collaboration sites.

In various implementations the active elements may include site icons for launching the collaboration sites. The icons can include a link or other data that, when selected, launches a corresponding one of the collaboration sites.

The active elements may also include news feed elements for interacting with news feeds associated with the collaboration sites. The news feed elements may include various news feed functions that allow a user to interact with the news feeds through the active elements, such as a post function, a reply function, and a like function. In an example, posts to the news feeds may be surfaced in the news feed elements and users may post their own messages through the news feed elements, including by replying to other posts. Users may also indicate that they like a particular post by way of the like function, all through the active elements in the active summaries.

Other examples of the active elements include documents icons for launching documents associated with a user's collaboration sites. The documents may be selected and surfaced in the active summaries based on their relevance, recentness, or based on some other criteria. The documents may be launched by clicking on, touching, or otherwise selecting their corresponding document icons.

In some implementations the active summaries are active cards arranged in a horizontally scrollable order in the home page. The active cards may be generally rectangular, although other shapes are possible, such as circular, square, or other shapes. Scrolling through the cards may he accomplished by various types of interactions with a user interface system, such as touching and scrolling to the left or right on a screen or using a mouse or other navigational tools to scroll horizontally. The cards may also be arranged in some other scrollable orientation, such as vertically, in a circle, or otherwise. Each active card may include a subset of the active elements that are specific to the active card.

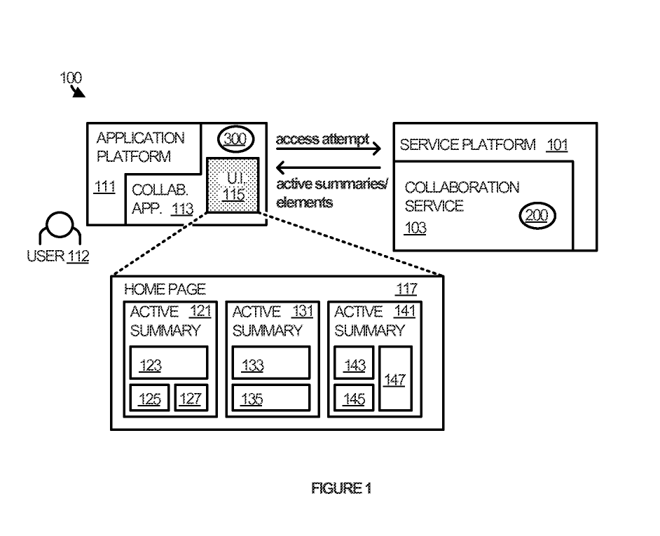

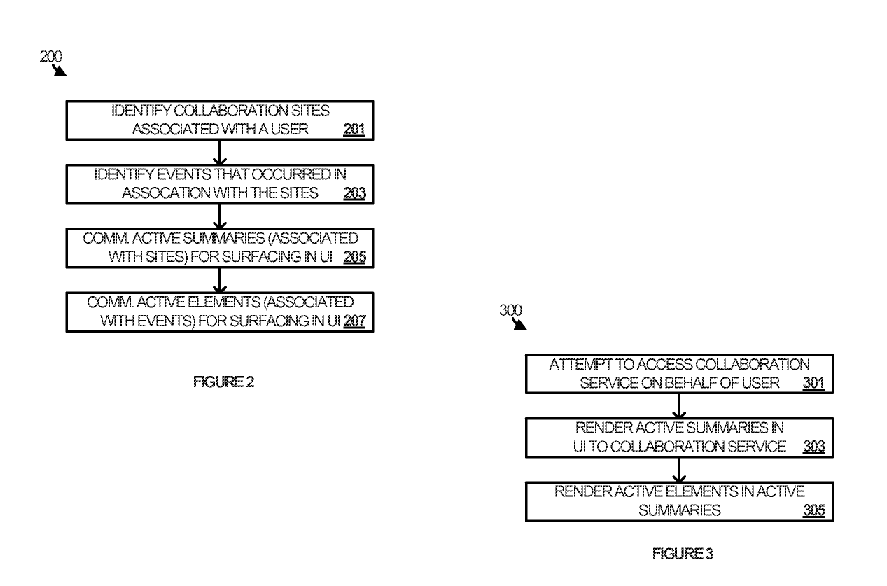

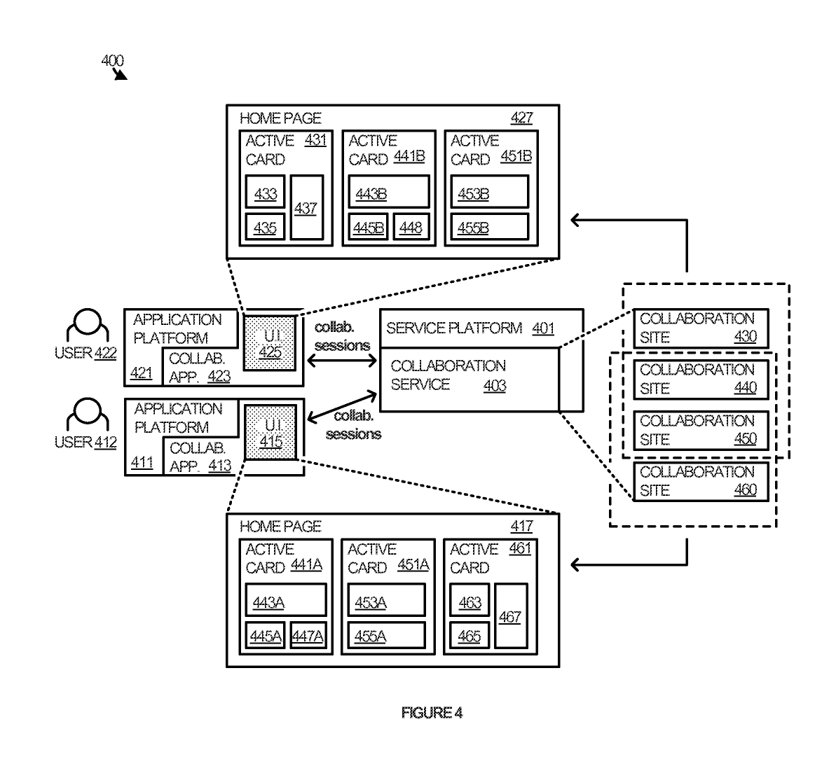

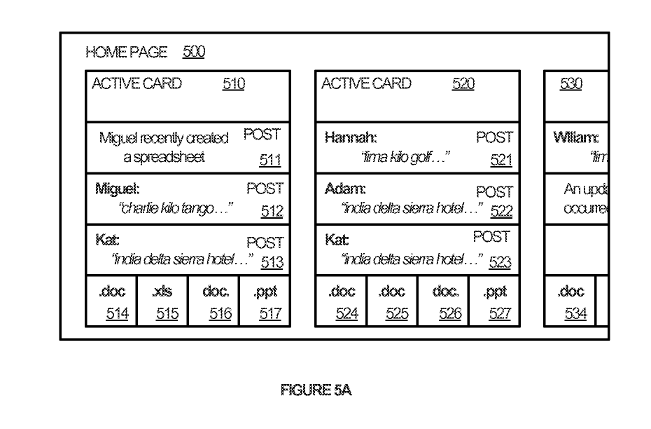

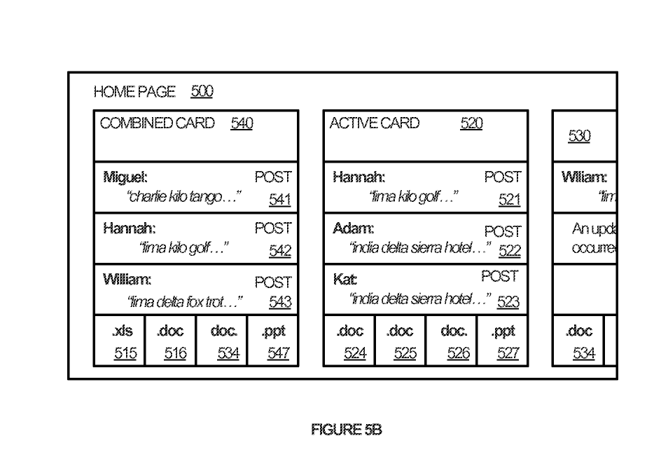

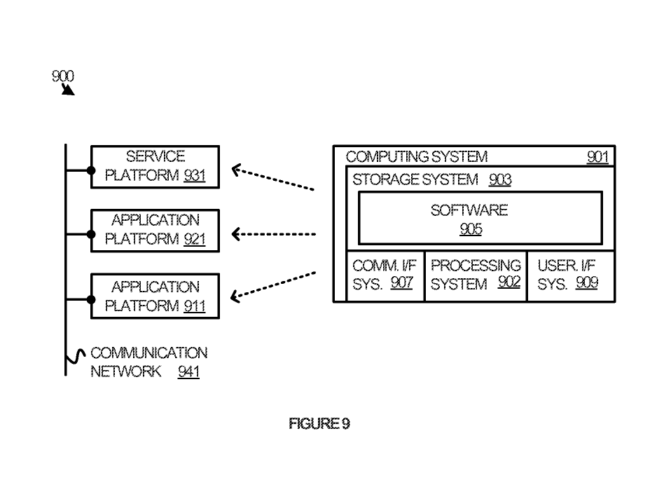

Turning now to the drawings, FIG. 1 illustrates a collaboration scenario in a collaboration application engages with a collaboration service to provide a user interface to the service. FIG. 2 illustrates a collaboration process employed by the collaboration service in the context of the scenario in FIG. 1, while FIG. 3 illustrates a collaboration process employed by the collaboration application in the same context. FIG. 4 illustrates another collaboration scenario in an implementation. FIGS. 5-8 illustrate various home pages that may be rendered in a user interface to a collaboration service. FIG. 9 illustrates a collaboration environment in which such applications, services, processes, and operational scenarios may be implemented.

Referring to FIG. 1, operational scenario 100 involves service platform 101 and application platform 111. Collaboration service 103 runs on service platform 101, while collaboration application 113 runs on application platform 111. Collaboration service 103 employs collaboration process 200 to facilitate enhanced user interfaces to the service. Collaboration application 113 employs collaboration process 300 to facilitate enhanced user interfaces to the services. Collaboration process 200 and collaboration process 300 are illustrated in FIG. 2 and FIG. 3 respectively.

In operation, user 112 interacts with collaboration service 103 by way of a user interface 115 to collaboration service 103 rendered on application platform 111 by collaboration application 113. Collaboration application 113 may initiate various access attempts on behalf of user 112 to access collaboration service 103. In some scenarios, user 112 may have to provide a login credentials, such as a user name and password, that collaboration application 113 communicates to collaboration service 103. Collaboration application 113 may use a uniform resource locator (URL), an Internet protocol (IP) address, or some other address or identifier to access collaboration service 103.

In response to an access attempt, collaboration service 103 communicates active summaries and active elements identified for user 112. It may be appreciated that collaboration service 103 may communicate other data and information in addition to the active summaries and active elements, Collaboration application 113 receives and renders the active summaries and active elements in a home page 117 in user interface 115.

Home page 117 includes active summary 121, active summary 131, and active summary 141. It may be appreciated that home page 117 could include fewer or more active summaries. Active summary 121, active summary 131, and active summary 141 correspond to collaboration sites associated with user 112. User 112 can obtain an update on collaboration activity that may have occurred with respect to any of the collaboration sites by simply viewing any of the active summaries 121, 131, and 141, and in particular the active elements in each active summary.

Active summary 121 includes active element 123, active element 125, and active element 127. Active summary 131 includes active element 133 and active element 135. Active summary 141 includes active element 143, active element 145, and active element 147. The active elements in each active summary may include, for example, icons for launching recent documents, tools for viewing news feeds or posting to the news feeds, thumbnails of pictures associated with a collaboration site, contacts for people associated with a site, or any other type of content of information that may be produced or consumed with respect to a collaboration site.

Referring to FIG. 2, collaboration service 103 employs collaboration process 200 in order to facilitate an enhanced user interface to the service. In response to access attempts associated with user 112, collaboration service 103 identifies which collaboration sites are associated with user 112 (step 201). This may be accomplished by, for example, checking a profile associated with user 112 that may include a list of his or her sites. In another example, site profiles for various sites may be checked to determine if user 112 is included in a list of users for each site. In yet another site, collaboration application 113 may provide a list of sites that are associated with user 112 to collaboration service 103. Still other ways in which to identify a user's collaboration sites are possible and may be considered within the scope of the present disclosure.

Events may then be identified that occurred in association with the sites associated with user 112 (step 203). Examples of events include events associated with document interaction, such as when a document is created, read, edited, or commented upon within the context of a collaboration site. Other examples include when calendar events are generated, sent, accepted, and scheduled, or when tasks are created, edits, and completed. Yet other examples of events include the posting of messages in social media feeds, replies to the messages, and the like.

Identifying the events may occur continuously in the background—even when user 112 is not logged into or otherwise accessing collaboration service 103. For example, events that occur with respect to each collaboration site may be evaluated algorithmically as they occur to determine whether or not they merit surfacing in an associated activity summary. As the events are evaluated, they may be noted or otherwise selected for inclusion in an active summary by way of corresponding active elements such that, when a user logs in, the active summary and its active elements are prepped and ready to be communicated down to collaboration application 113.

In other scenarios the events may be identified after the fact—once user 112 has logged into collaboration service 103. For instance, events may be tracked while user 112 is logged out and then evaluated algorithmically when user 112 logs into collaboration service 103. Some combination of the two strategies is also possible, as well as any other strategy or variation thereof.

Collaboration service 103 communicates the active summaries to collaboration application 113 for surfacing in user interface 115, and specifically for surfacing in home page 117 in some implementations (step 205). Collaboration service 103 also communicates the active elements to collaboration application 113 for surfacing in user interface 115 (step 207). In some scenarios, at least some of the active elements may be communicated to collaboration application 113 at the substantially the same time as when the active summaries are communicated. However, in some scenarios the active elements may be communicated after the active summaries.

In fact, the active elements may change over time as the events with which they are associated are continuously evaluated. For instance, a first set of active elements may have been communicated to collaboration application 113 upon user 112 logging into collaboration service 103. However, as user 112 returns to home page 117 from one or more of his or her collaboration sites, a new set of active elements may have been or can be communicated to collaboration application 113. It is also possible that, even when the active elements remain unchanged, new information is surfaced in them when user 112 returns to home page 117 relative to when having just logged into collaboration service 103.

Referring to FIG. 3, collaboration application 113 employs collaboration process 300 in order to facilitate an enhanced user interface to collaboration service 103. User 112 may interact with collaboration application to drive it to attempt to access collaboration service 103 (step 301). Such attempts may include logging into collaboration service 103, navigating back to home page 117, or any other type of access attempt.

Collaboration application 113 exchanges communications with collaboration service 103 in order to establish access through which user 112 may engage in various collaboration sessions with other people associated with his or her collaboration sites. As part of the exchange to establish access, collaboration service 103 identifies and communicates active summaries corresponding to the sites associated with user 112. Collaboration application 113 receives the active summaries and renders them in user interface 115 (step 303). In some implementations this may include rendering the active summaries in home page 117.

Collaboration application 113 also receives and renders active elements communicated by collaboration service 103 (step 305). As discussed, the active elements may be provided at substantially the same time as the active summaries. However, in some implementations the active elements are provided later or are updated periodically as their corresponding events are evaluated algorithmically for relevance, recentness, and the like.

Rendering as used herein may refer to any or all steps performed in the complex process of processing data such that it may be experienced by a human in some type of user interface system. Depending upon how collaboration process 300 is implemented, rendering may refer to the step or steps involved in assembling objects and information, such as active summaries and active elements, and calling a rendering engine to produce processed versions of the objects and information. The processed versions may then be handed off to yet another software or hardware layer in a computing environment and are eventually output in a form that may be experienced by a human, such as a visual or audible form, or both. Collaboration process 300 may be implemented in such a way that rendering refers to some or all of the steps performed by a rendering engine to produce a processed version of the objects and information that, when rendered, represent the active summaries.

For example, collaboration process 300 may be employed in a web application that runs in the context of a web browser. In such scenarios, rendering may refer to the step or steps performed by the web application when invoking the web browser to render a page, an image, or some other rendered experience. However, collaboration process 300 may be distributed across multiple applications in some scenarios, including the web browser, in which case rendering may refer to the steps performed by the browser's rendering engine when rendering pages, images, video, or other rendered experiences. In yet another example, collaboration process 300 may be distributed across still other applications or sub-systems, such as the graphics engine in a computing system, in which case rendering may refer to some or all of the steps carried out by such applications or sub-systems when rendering an image, video, or other experiential content.

Referring back to FIG. 1, service platform 101 is representative of any physical or virtual computing system, device, or collection thereof capable of hosting all or a portion of collaboration service 103 and performing collaboration process 200. Examples of service platform 101 include, but are not limited to, server computers, web servers, application servers, rack servers, blade servers, virtual machine servers, or tower servers, as well as any other type of computing system, of which computing system 901 illustrated in FIG. 9 is representative. In some scenarios, collaboration service 103 may be implemented in a data center, a virtual data center, or in some other suitable computing facility. Collaboration service 103 may sometimes be referred to as a cloud service, an online service, an Internet service, or the like.

Application platform 111 is representative of any physical or virtual computing system, device, or collection thereof capable of running collaboration application 113 to support user interface 115 and perform collaboration process 300. Examples of application platform include, but are not limited to, smart phones, laptop computers, tablet computers, desktop computers, hybrid computers, gaming machines, smart televisions and virtual machines, as well as any variation or combination thereof, of which computing system 901 is representative.

Collaboration application 113 is representative of any software application, module, component, or collection thereof, capable of communicating with collaboration service 103 and rendering user interface 115. Collaboration application 113 may be a locally installed and executed application, a streamed application, a mobile application, or any combination or variation thereof. In some implementations, collaboration application 113 may be browser-based application that executes in the context of a browser application. Collaboration application 113 may be implemented as stand-alone application or may be distributed across multiple applications or sub-systems.

FIG. 4 illustrates collaboration scenario 400 in an implementation. Collaboration scenario 400 involves service platform 401, application platform 411, and application platform 421. Collaboration service 403 runs on service platform 401. Collaboration application 413 and collaboration application 423 run on application platform 411 and application platform 421 respectively. Collaboration service 403 hosts collaboration site 430, collaboration site 440, collaboration site 450, and collaboration site 460.

In operation, user 412 accesses various ones of the collaboration sites hosted by collaboration service 403 via user interface 415, which is generated at least in part by collaboration application 413. User 422 also accesses various ones of the collaboration sites hosted by collaboration service 403 via user interface 425, which is generated at least in part by collaboration application 423. In this scenario, user 412 is associated with collaboration site 440, collaboration site 450, and collaboration site 460. User 422 is associated with collaboration site 430, collaboration site 440, and collaboration site 450. Thus, it may be appreciated that user 412 and user 422 have collaboration sites 440 and 450 in common.

Collaboration application 413 interfaces with collaboration service 403 to provide user 412 with access to collaboration sites 440, 450, and 460. Collaboration application 413 also provides home page 417, which is a page from which user 412 can navigate to his or her various collaboration sites. Home page 417 includes active summaries that correspond to the sites associated with user 412. In this scenario, the active summaries are active cards, represented by active card 441A, active card 451A and active card 461.

Active card 441A is a card that provides a summary of collaboration activity that occurs with respect to collaboration site 440. Active card 451A provides a summary of collaboration activity with respect to collaboration site 450. Active card 461 provides a summary of collaboration activity with respect to collaboration site 460. Collaboration service 403 communicates the active cards to collaboration application 413 for rendering in user interface 415.

Active card 441A includes various active elements that correspond to collaboration events that occur on collaboration site 440, such as document comments and edits, calendar events, and social media events. Active element 443A, active element 445A, and active element 447A are representative active elements. User 412 may interact with the active elements in active card 441A to launch associated documents, read or post to social media feeds, launch calendar functions, or perform any of a variety of other functions within the context of collaboration site 440.

Active card 451A includes various active elements that correspond to collaboration events that occur on collaboration site 450, such as document comments and edits, calendar events, and social media events. Active element 453A and active element 455A are representative of such active elements. User 412 may interact with the active elements in active card 451A to launch associated documents, read or post to social media feeds, launch calendar functions, or perform any of a variety of other functions within the context of collaboration site 450.

Active card 461 includes various active elements that correspond to collaboration events that occur on collaboration site 460, such as document comments and edits, calendar events, and social media events. Active element 463, active element 465, and active element 467 are representative of such active elements. User 412 may interact with the active elements in active card 461 to launch associated documents, read or post to social media feeds, launch calendar functions, or perform any of a variety of other functions within the context of collaboration site 460.

Collaboration application 423 interfaces with collaboration service 403 to provide user 422 with access to collaboration sites 430, 440, and 450. Collaboration application 423 also provides home page 427, which is a page from which user 422 can navigate to his or her various collaboration sites. Home page 427 includes active summaries that correspond to the sites associated with user 422. In this scenario, the active summaries are active cards, represented by active card 431, 441B, and active card 451B.

Active card 441B is a card that provides a summary of collaboration activity that occurs with respect to collaboration site 440. Active card 451B provides a summary of collaboration activity with respect to collaboration site 450. Active card 431 provides a summary of collaboration activity with respect to collaboration site 430. Collaboration service 403 communicates the active cards to collaboration application 423 for rendering in user interface 425.

Active card 441B includes various active elements that correspond to collaboration events that occur on collaboration site 440, such as document comments and edits, calendar events, and social media events. Active element 443B, active element 445B, and active element 448 are representative of such active elements. User 422 may interact with the active elements in active card 441B to launch associated documents, read or post to social media feeds, launch calendar functions, or perform any of a variety of other functions within the context of collaboration site 440. It may be appreciated that the elements of active card 441B are not exactly the same as those found in active card 441A. This illustrates that the active cards for a collaboration site that two or more users have in common may vary by at least one active element.

Active card 451B includes various active elements that correspond to collaboration events that occur on collaboration site 450, such as document comments and edits, calendar events, and social media events. Active element 453B and active element 455B are representative of such active elements. User 422 may interact with the active elements in active card 451B to launch associated documents, read or post to social media feeds, launch calendar functions, or perform any of a variety of other functions within the context of collaboration site 450.

Active card 431 includes various active elements that correspond to collaboration events that occur on collaboration site 430, such as document comments and edits, calendar events, and social media events. Active element 433, active element 435, and active element 437 are representative of such active elements. User 422 may interact with the active elements in active card 431 to launch associated documents, read or post to social media feeds, launch calendar functions, or perform any of a variety of other functions within the context of collaboration site 430.

FIG. 5A illustrates a home page 500 that is representative of home page 417 and home page 427. Home page 500 includes various active cards that may be representative of the active cards in home page 417 and home page 427. In particular, home page 500 includes active card 510, active card 520, and active card 530. Active card 530 is only partially visible within home page 500 to give the effect that the active cards are arranged in a horizontally scrollable manner. A user interacting with home page 500 could scroll to the right to unveil active card 530 (or additional cards), which would move active card 510 to the left and render it less visible or completely out of sight.

Active card 510 includes various active elements 511-517 representative of the active elements illustrated in home page 417 and home page 427. Active element 511, active element 512, and active element 513 are representative of active elements that may allow a user to interact with asocial news feed for a collaboration site, such as by consuming messages in a social news feed. As examples, active element 511 includes a post to a social news feed indicating that a user recently created a spreadsheet, active element 512 includes a post to the social news feed by a user, and active element 512. includes a post by another user associated with the collaboration site.

Active element 514, active element 515, active element 516, and active element 517 are representative of active elements that may allow a user to interact with documents or other content objects associated with a collaboration site. Active element 514 is associated with a document, active element 515 is associated with a spreadsheet, active element 516 is associated with another document, and active element 517 is associated with a presentation. Each of the active elements 514, 515, 516, and 517 may be clicked on, touched, or otherwise selected to launch their associated content objects in a corresponding productivity application. Other functions may also be possible, such as the ability to forward, copy, or save the documents from within active card 510. Active elements 514, 515, 516, and 517 may be dynamically selected for surfacing in active card 510 algorithmically. Which documents and associated active elements are selected for surfacing may vary over time.

Active card 520 is similar to active card 510 in that it, too, includes posts from various users and active elements associated with various documents. In particular, active card 520 includes active element 521, active element 522, and active element 523, which are representative of active elements that may allow a user to interact with a social news feed for a collaboration site, such as by consuming messages in a social news feed. As examples, active element 521 includes a post to a social news feed by a user, active element 522 includes a post to the social news feed by another user, and active element 523 includes a post by another user associated with the collaboration site.

Active element 524, active element 525, active element 526, and active element 527 are representative of active elements that may allow a user to interact with documents or other content objects associated with a collaboration site. Active element 524 is associated with a document, active element 525 is associated with a document, active element 526 is associated with another document, and active element 527 is associated with a presentation. Each of the active elements 524, 525, 526, and 527 may be clicked on, touched, or otherwise selected to launch their associated content objects in a corresponding productivity application. Other functions may also be possible, such as the ability to forward, copy, or save the documents from within active card 520. Active elements 524, 525, 526, and 527 may be dynamically selected for surfacing in active card 520 algorithmically. Which documents and associated active elements are selected for surfacing may vary over time.

FIG. 5B illustrates another view of home page 500 relative to FIG. 5A. In FIG. 5B, home page 500 includes a combined card 540, in addition to active card 520 and active card 530. Combined card 540 is representative of an active card that may be generated for a user and through which active elements for multiple collaboration sites may be aggregated and surfaced.

In this example, combined card 540 includes active element 541, active element 542, and active element 543, which are active elements for interacting with social media feeds. Indeed, it may be appreciated that active element 541 includes a post associated with one collaboration site, while active element 542 includes a post for another collaboration site, while active element 543 includes a post for yet another collaboration site. Combined card 540 also includes active element 515, active element 516, active element 534, and active element 547, which are representative of active elements that may be used to interact with documents or other content objects associated with multiple collaboration sites.

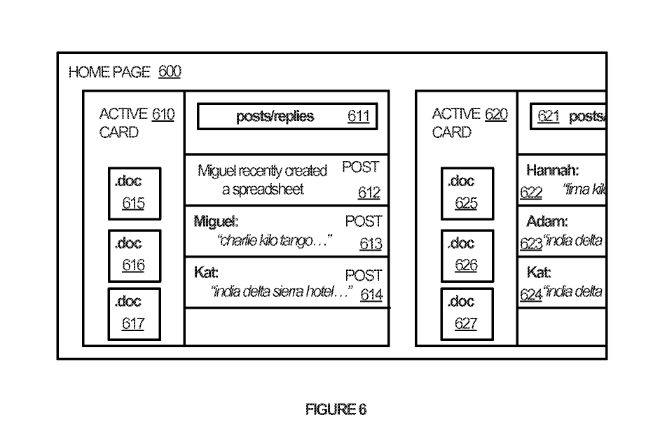

FIG. 6 illustrates home page 600 in an implementation. Home page 600 is representative of home page 417 and home page 427 in another implementation in which the active cards include active elements for posting and replying to messages in a social media feed. Home page 600 includes various active cards that may be representative of the active cards in home page 417 and home page 427. In particular, home page 600 includes active card 610 and active card 620. Active card 620 is only partially visible within home page 600 to give the effect that the active cards are arranged in a horizontally scrollable manner. A user interacting with home page 600 could scroll to the right to unveil active card 620 (or additional cards), which would move active card 610 to the left and render it less visible or possibly completely out of sight.

Active card 610 includes active element 611, active element 612, active element 613, and active element 614. Active element 611 is representative of an element through which a user may post messages to a social news feed or reply to other posts. Active element 611 is active in the sense that the user may post directly from it, rather than having to navigate to a different site in order to post. The user may consume posts through active elements 612, 613, and 614. Active card 610 also includes active elements 615, 617, and 617, which are representative of active elements that may allow a user to launch documents, spreadsheets, presentations, or other such content that may be identified for surfacing in active card 610.

Active card 620 also includes an active element 621 for posting messages or replying to messages in a social news feed. Again, a user may interact directly with active element 621 to generate posts, rather than having to navigate away from home page 600 to a collaboration site associated with active card 620. Active card 620 also includes active elements 622, 623, and 624 through which social media posts made by other people may be surfaced. Active elements 625, 626, and 627 represent documents and other content objects that may be algorithmically identified and surface in active card 620.

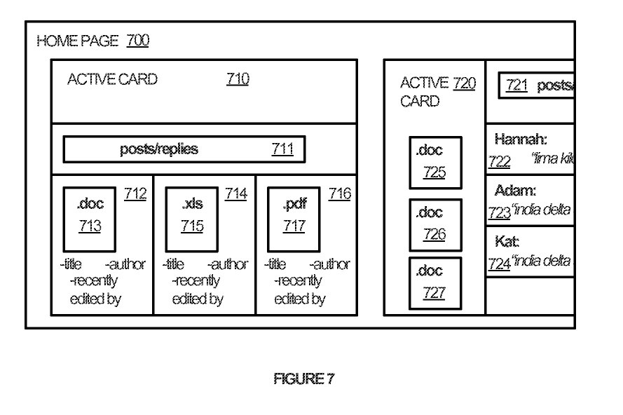

FIG. 7 illustrates home page 700 in an implementation. Home page 700 is representative of home page 417 and home page 427 in another implementation in which the active cards include active elements for posting and replying o messages in a social media feed, but are also arranged differently relative to each other. The active cards also include active elements that relate both to documents and meta-data about the documents.

Home page 700 includes various active cards that may be representative of the active cards in home page 417 and home page 427. In particular, home page 700 includes active card 710 and active card 720. Active card 720 is only partially visible within home page 700 to give the effect that the active cards are arranged in a horizontally scrollable manner. A user interacting with home page 700 could scroll to the right to unveil active card 720 (or additional cards), which would move active card 710 to the left and render it less visible or possibly completely out of sight.

Active card 710 includes active element 711, active element 612, active element 712, active element 714, and active element 716. Active elements 712, 714, and 716 include active elements 713, 715, and 717 respectively.

Active element 711 is representative of an element through which a user may post messages to a social news feed or reply to other posts. Active element 711 is active in the sense that the user may post directly from it, rather than having to navigate to a different site in order to post.

Active elements 712, 714, and 716 include information about various documents or other content objects that may be algorithmically identified for inclusion in active card 710. Active elements 713, 715, and 717 are visually layered on or within active elements 712, 714, and 716. It may be appreciated that each combination of elements may be considered a single element. Information about the identified content objects may be surfaced in active elements 712, 714, and 715, such as the title or author of the content objects, or by whom the objects were most recently edited by. Other types of information, such as the identity of users that commented on a document, may also be included in addition to or in place of the information described herein. Users may interact with active elements 713, 715, and 717 to launch, copy, or edit their associated content objects.

Active card 720 includes different types of active elements than active card 710, and thus illustrates that the style and nature of active cards in an active summary may differ relative to each other. In this implementation, active card 720 includes active element 721 through which a user may directly post to a social news feed. Active card 720 also includes active elements 722, 723, and 724 for consuming posts by users associated with its collaboration site and active elements 725, 726 and 727 for interacting with content objects.

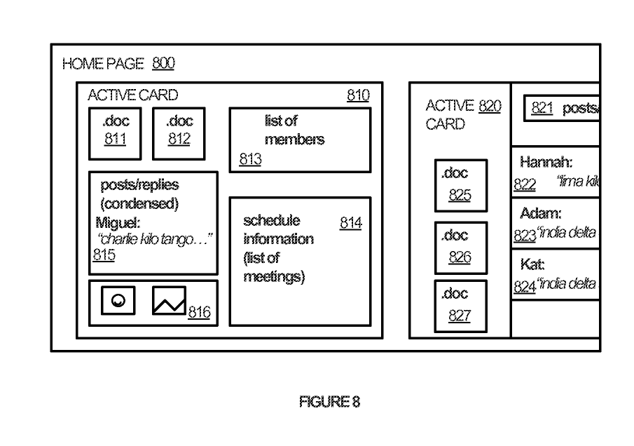

FIG. 8 illustrates another home page 800 that is representative of home page 417 and home page 427 in an implementation. Home page 800 includes active card 810 and active card 820. Active card 810 and active card 820 differ in the types of active elements included in each respective card, thus illustrating again that active cards in an active summary may vary.

Active card 810 includes active elements 811 and 812, which may be used for interacting with documents, spreadsheets, and other content objects that may be found in a collaboration site. Active element 813 is also included, which is an element for listing at least some of the members of a collaboration site. Active element 813 may include the names or aliases of users and possibly other interactive information, such as contact information for the members or other active elements with which to interact with contacts for the member. Active card 810 includes active element 814 for viewing schedule information. Active element 814 may display dates and times of scheduled events and may include other active element for interacting with the events. As schedules change with respect to the collaboration site associated with active card 810, the information in active element 814 may change dynamically. Active element 815 is an element for consuming posts by other users or possibly originating posts to a social media feed. Lastly, active card 810 includes active element 816 for viewing images and other media content associated with a collaboration site.

Active card 820, in contrast, includes a different set of active elements. Namely, active card 820 includes active element 821 for originating posts in a social news feed associated with a collaboration site. Active card 820 also includes active elements 822, 823, and 824 for surfacing posts to the social news feed by users. Active elements 825, 826, and 827 correspond to documents and other content objects that may be identified algorithmically for surfacing in active card 820. A user may interact with active elements 825, 826, and 827 to launch, copy, share, the documents, for example.

FIG. 9 illustrates a collaboration environment 900 that is representative of an environment in which the various operational scenarios and processes disclosed herein may be implemented. Collaboration environment 900 includes application platform 911, application platform 921, and service platform 931.

Application platforms 911 and 921 are each representative of any computing apparatus, system, device, or collections thereof suitable for implementing a collaboration application. Examples of application platforms 911 and 921 include, but are not limited to, smart phones, laptop computers, tablet computers, desktop computers, hybrid computers, gaining machines, virtual machines, smart televisions, and watches and other wearable devices, as well as any variation or combination thereof.

Service platform 931 is representative of any computing apparatus, system, or collections thereof capable of implementing all or portions of a collaboration service. Examples of service platform 921 include server computers, rack servers, web servers, cloud computing platforms, and data center equipment, as well as any other type of physical or virtual server machine, and any variation or combination thereof. In some implementations, a collection of multiple computing systems may be employed to implement all or portions of a collaboration service which may be hosted in one or more data centers, virtual data centers, or any other suitable computing facilities.

Computing system 901 is an example of application platform 911, application platform 921, and service platform 931. Computing system 901 may be implemented as a single apparatus, system, or device or may be implemented in a distributed manner as multiple apparatuses, systems, or devices. Computing system 901 includes, but is not limited to, processing system 902, storage system 903, software 905, communication interface system 907, and user interface system 909. Processing system 902 is operatively coupled with storage system 903, communication interface system 907, and user interface system 909.

Processing system 902 loads and executes software 905 from storage system 903. When executed by processing system 902 to implement enhanced collaboration services and user interfaces thereto, software 905 directs processing system 902 to operate as described herein for the various processes, operational scenarios, and sequences discussed in foregoing implementations. Computing system 901 may optionally include additional devices, features, or functionality not discussed for purposes of brevity.

Referring still to FIG. 9, processing system 902 may comprise a microprocessor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 may be implemented in program instructions and among other functions may, when executed by processing system 902, direct processing system 902 to operate as described with respect to the various operational scenarios, sequences, and processes illustrated herein. When computing system 901 is deployed as an application platform (e.g. application platforms 111, 411, 421, 911, and 921), software 905 may include program instructions for implementing a collaboration application and its associated functionality, such as collaboration applications 113, 413, and 423. When computing system 901 is deployed as a service platform (e.g. service platforms 101, 401, and 931), software 905 may include program instructions for implementing a collaboration service and its associated functionality, such as collaboration services 103 and 403.

In particular, the program instructions may include various components or modules that cooperate or otherwise interact to carry out the various processes and operational scenarios described herein. The various components or modules may be embodied in compiled or interpreted instructions or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software or other application software. Software 905 may also comprise firmware or some other form of machine-readable processing instructions executable by processing system 902.

In general, software 905 may, when loaded into processing system 902 and executed, transform a suitable apparatus, system, or device (of which computing system 901 is representative) overall from a general-purpose computing system into a special-purpose computing system customized to facilitate enhanced collaboration services and user interfaces to such services. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical slate of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Referring again to FIG. 1 as an example, through the operation of a computing system or systems of which computing system 901 is representative, transformations may be performed with respect to user interface 115. As an example, collaboration application 113 accesses collaboration service 103, in response to which active summaries and active elements are identified for downloading and presenting in home page 117. User interface 115 is thus transformed from an initial state without the active summaries or elements to a state with the active summaries and elements.

It may be understood that computing system 901 is generally intended to represent a computing system or systems on which software 905 may be deployed and executed in order to implement enhanced user interfaces to collaboration services. However, computing system 901 may also be suitable as any computing system on which software 905 may be staged and from where one or both may be distributed, transported, downloaded, or otherwise provided to yet another computing system for deployment and execution, or yet additional distribution.

Communication interface system 907 may include communication connections and devices that allow for communication with other computing systems (not shown) over communication network 941. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 909 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 909. In some cases, the input and output devices may be combined in a single device, such as a display capable of displaying images and receiving touch gestures. The aforementioned user input and output devices are well known in the art and need not be discussed at length here.

User interface system 909 may also include associated user interface software executable by processing system 902 in support of the various user input and output devices discussed above. Separately or in conjunction with each other and other hardware and software elements, the user interface software and user interface devices may support a graphical user interface, a natural user interface, or any other type of user interface. For example, user interface 115, user interface 415, user interface 425, home page 117, home page 417, home page 427, home page 500, home page 600, home page 700, and home page 800 may be presented through user interface system 909. In addition, user input made with respect to the user interfaces can be input via user interface system 909.

Communication between application platform 911, application platform 921, and service platform 931 and any other computing system occurs over communication network 941 or other networks and in accordance with various communication protocols, combinations of protocols, or variations thereof. Examples of communication network 941 include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

While FIGS. 1-9 generally depict relatively few users and relatively few instances of service platforms, collaboration services, application platforms, and collaboration applications, it may be appreciated that the concepts disclosed herein may be applied at scale. For example, the collaboration applications and services disclosed herein could be deployed in support of any number of users.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of operating a collaboration service to facilitate a presentation of a user interface to the collaboration service comprising:
identifying at least a plurality of collaboration sites associated with a user;
identifying at least a plurality of events that occurred with respect to the plurality of collaboration sites;
communicating at least a plurality of active summaries for surfacing in the user interface that correspond to the plurality of collaboration sites associated with the user; and
communicating at least a plurality of active elements for surfacing in the plurality of active summaries indicative of at least the plurality of events that occurred with respect to the plurality of collaboration sites.

2. The method of claim 1 wherein the user interface includes a home page and wherein the method further comprises presenting at least the plurality of active summaries together in the home page.

3. The method of claim 2 wherein the plurality of active elements includes a plurality of site icons for launching the plurality of collaboration sites and wherein the method further comprises, in response to a selection of one of the plurality of site icons, launching a corresponding one of the plurality of collaboration sites.

4. The method of claim 3 wherein the plurality of active elements includes a plurality of news feed elements for interacting with a plurality of news feeds associated with the plurality of collaboration sites and wherein the method further comprises surfacing posts to the plurality of news feeds in the plurality of news feed elements.

5. The method of claim 4 wherein each news feed element of the plurality of news feed elements includes a plurality of news feed functions for interacting with a corresponding one of the plurality of news feeds, wherein the plurality of news feed functions includes a post function for posting to a news feed, a reply function for replying to posts in the news feed, and a like function for liking the posts in the news feed.

6. The method of claim 3 wherein the plurality of active elements includes a plurality of document icons for a plurality of documents associated with the plurality of collaboration sites wherein the method further comprises, in response to a selection of one of the plurality of document icons, launching a corresponding one of the plurality of documents.

7. The method of claim 2 wherein the plurality of active summaries comprises a plurality of active cards and wherein presenting at least the plurality of active summaries in the user interface includes arranging the plurality of active cards in a horizontally scrollable order in the home page.

8. The method of claim 7 wherein each active card of the plurality of active cards includes a subset of the plurality of active elements that are specific to the active card.

9. One or more computer readable storage media having program instructions stored thereon for presenting a user interface to a collaboration service that, when executed by a processing system, direct the processing system to at least:
render at least a plurality of active summaries the user interface that correspond to a plurality of collaboration sites associated a user; and
render at least a plurality of active elements in the plurality of active summaries indicative of at least a plurality of events that occurred with respect to the plurality of collaboration sites.

10. The one or more computer readable storage media of claim 9 wherein the user interface includes a home page and wherein, to render at least the plurality of active summaries in the user interface, the program instructions direct the processing system to render at least the plurality of active summaries together in the home page.

11. The one or more computer readable storage media of claim 10 wherein the plurality of active elements includes a plurality of site icons for launching the plurality of collaboration sites and wherein the program instructions further direct the processing system to, in response to a selection of one of the plurality of site icons, launch a corresponding one of the plurality of collaboration sites.

12. The one or more computer readable storage media of claim 11 wherein the plurality of active elements includes a plurality of news feed elements for interacting with a plurality of news feeds associated with the plurality of collaboration sites and wherein the program instructions further direct the processing system to surface posts to the plurality of news feeds in the plurality of news feed elements.

13. The one or more computer readable storage media of claim wherein each news feed element of the plurality of news feed elements includes a plurality of news feed functions for interacting with a corresponding one of the plurality of news feeds, wherein plurality of news feed functions includes a post function for posting to a news feed, a reply function for replying to posts in the news feed, and a like function for liking the posts in the news feed.

14. The one or more computer readable storage media of claim 11 wherein the plurality of active elements includes a plurality of document icons for a plurality of documents associated with the plurality of collaboration sites wherein the program instructions further direct the processing system to, in response to a selection of one of the plurality of document icons, launch a corresponding one of the plurality of documents.

15. The one or more computer readable storage media of claim 10 wherein the plurality of active summaries comprises a plurality of active cards and wherein, to present at least the plurality of active summaries in the user interface, the program instructions direct the processing system to arrange the plurality of active cards in a horizontally scrollable order in the home page.

16. The one or more computer readable storage media of claim 15 wherein each active card of the plurality of active cards includes a subset of the plurality of active elements that are specific to the active card.

17. An apparatus comprising:
one or more computer readable storage media; and
program instructions stored on the one or more computer readable storage media for presenting a user interface to a collaboration service that, when executed by a processing system, direct the processing system to at least:
identify information relevant to at least a collaboration site associated with a user attempting to access the collaboration service;
render a home page in the user interface comprising an active card that corresponds to the collaboration site; and
render a plurality of active elements in the active card with which to display the information and through which to receive user interaction associated with the user with respect to at least a portion of the information.

18. The apparatus of claim 17 further comprising the processing system that executes the program instructions and a user interface system that displays the home page in the user interface.

19. The apparatus of claim 17 wherein the plurality of active elements includes a site icon for launching the collaboration site, a news feed element for interacting with a news feed associated with the collaboration site, and a plurality of document icons for opening a plurality of documents associated with the collaboration site.

20. The apparatus of claim 19 wherein the new feed element includes a plurality s feed functions for interacting with the news feed, including a post function for posting to the news feed, a reply function for replying to posts in the news feed, and a like function for liking the posts in the news feed.
